(19) United States
(12) Patent Application Publication
(10) Pub. No.: US 2016/0111206 A1
(43) Pub. Date: Apr. 21, 2016

(54) TRANSFORMER

(71) Applicant: FDK CORPORATION, Tokyo (JP)

(72) Inventors: Yuki TAKEUCHI, Tokyo (JP); Takashi TAKIGUCHI, Tokyo (JP); Kiyoshi HIRONAKA, Tokyo (JP); Satoshi OTA, Tokyo (JP)

(21) Appl. No.: 14/787,376

(22) PCT Filed: Apr. 7, 2014
(86) PCT No.: PCT/JP2014/001987

§ 371 Date: Oct. 27, 2015

(30) Foreign Application Priority Data
May 9, 2013 (JP) 2013-099504

(51) Int. Cl. H01F 27/32; H01F 27/28

(52) U.S. Cl. CPC H01F 27/325; H01F 27/2823; H01F 27/2871

(57) ABSTRACT

A transformer capable of readily ensuring a predetermined insulation distance with no increase in the overall size of the transformer and further capable of reducing the number of constituent parts to achieve cost reduction. According to the present invention, the transformer includes a first bobbin having a wire winding section and a flange formed at an end of the wire winding section, a first coil wound around the wire winding section of the first bobbin, a second coil disposed coaxially with the first coil and adjacent to the flange, and a core disposed around the outer circumferences of the first and second coils to form a closed magnetic circuit, and a tubular protrusion that axially extends and surrounds the outer circumference of the second coil is formed along an outer circumferential portion of the flange of the first bobbin.

### TECHNICAL FIELD

The present invention relates to a transformer having a configuration preferably used in a switching power supply and other high-current-specification apparatus.

### BACKGROUND ART

In a transformer used in a switching power supply in an electric automobile or any other apparatus, a coil using a conductor having a large cross-sectional area is used to suppress heat generation due to high current. For example, Patent Literature 1 described below proposes a transformer using a flat copper wire having a large cross-sectional area and wound in an edgewise manner as a high-voltage coil and a low-voltage coil.

Further, as another high-current-specification transformer, there is a known transformer using a stranded wire having a small AC resistance value as a high-voltage coil.

FIG. 3 shows a transformer of this type formed as follows: A stranded wire is wound around a bobbin 1 to form a high-voltage coil 2; the coil 2 is accommodated in a pair of bottomed, cylindrical, insulating cases 3 and 4; a low-voltage coil 5, which is produced in a stamping process in which a metal flat plate is stamped in an open ring shape, is disposed coaxially with the high-voltage coil 2 on each of a bottom plate 3a of the case 3 and a top plate 4a of the case 4; and middle legs of a pair of E-shaped cores 6 are inserted into the low-voltage coils 5 and the bobbin 1 and outer legs of the cores 6 are located around the outer circumferences of the low-voltage coils 5 and the cases 3 and 4 to form a closed magnetic circuit. In FIG. 3, reference character 7 denotes an insulating plate having a circular ring plate shape interposed between each of the low-voltage coils 5 and the corresponding core 6.

According to the thus configured transformer, the cases 3 and 4 and the plates 7 ensure creeping distances between the high-voltage coil 2 and the low-voltage coils 5 and between the high-voltage coil 2 and the cores 6.

In the transformer having the configuration described above, however, the two cases 3 and 4 and the two plates 7 are required to ensure the creeping distances described above, undesirably resulting in an increase in the number of parts and hence increases in part manufacturing cost, management cost, assembly cost, and other types of cost.

To avoid the situation described above, it is conceivable to omit the cases 3 and 4 but employ a configuration in which axially thick flanges 8a of a bobbin 8 ensure a creeping distance L as shown in FIG. 4. However, as a result of an increase in the separation distance between the high-voltage coil 2 and the low-voltage coils 5, the following problems arise: The overall size of the transformer increases; and the amount of magnetic flux leakage increases to degrade the characteristics of the transformer.

Further, since the stranded wire that forms the high-voltage coil 2 has poor shape retaining capability, the following problems may arise: The wound wire of the high-voltage coil 2 is bent, so that the bent wire approaches a bonding section 5a, which bonds the low-voltage coils 5 to each other, and the creeping distance between the high-voltage coil 2 and the low-voltage coils 5 cannot therefore be ensured; or a drawn wire 2a drawn from the high-voltage coil 2 is bent, so that the creeping distance between the high-voltage coil 2 and the cores 6 cannot be ensured.

### CITATION LIST

### Patent Literature

Patent Literature 1: Japanese Patent Laid-Open No. 2000-223320

### SUMMARY OF INVENTION

### Technical Problem

The present invention has been made in view of the circumstances described above, and an object of the present invention is to provide a transformer capable of readily ensuring a predetermined insulation distance with no increase in the overall size of the transformer and further capable of reducing the number of constituent parts to achieve cost reduction.

### Solution to Problem

To achieve the object described above, a first aspect of the present invention (invention described in claim 1) relates to a transformer comprising: a first bobbin having a wire winding section and a flange formed at an end of the wire winding section; a first coil wound around an outer circumference of the wire winding section of the first bobbin; a second coil disposed coaxially with the first coil and adjacent to the flange; and a core disposed around outer circumferences of the first and second coils to form a closed magnetic circuit, wherein a tubular protrusion that axially extends and surrounds the outer circumference of the second coil is formed along an outer circumferential portion of the flange of the first bobbin.

A second aspect of the present invention (invention described in claim 2) is characterized in that in the first form described above (invention described in claim 1), an insulating member having a flat plate shape is disposed between the second coil and the core, and a second protrusion that protrudes into a space between the protrusion and the outer circumference of the second coil is formed on a surface of the insulating member on a side facing the second coil.

Further, a third aspect of the present invention (invention described in claim 3) provides, in the first or second aspect of the invention described above (invention described in claim 1 or 2), a transformer in which the first coil is a high-voltage coil with a stranded wire wound around the wire winding section, and the second coil is a low-voltage coil formed of a metal flat plate shaped in an open circular ring.

On the other hand, a fourth aspect of the present invention (invention described in claim 4) provides, in the first or second aspect of the invention described above (invention described in claim 1 or 2), a transformer in which the first coil is a high-voltage coil with a stranded wire wound around the wire winding section and is disposed in a bottomed, tubular, insulating cover, the second coil is wound around a second bobbin and disposed on a side facing an opening of the insulating cover, and a flange of the second bobbin that is located on the side facing the opening is formed to have a diameter greater than a diameter of the protrusion on the first bobbin.

### Advantageous Effects of Invention

According to any of the first to fourth aspects (invention described in any of claims 1 to 4), in which the tubular protrusion that axially extends and surrounds the outer circumference of the second coil, is formed along the outer circumferential portion of the flange of the first bobbin, around which the first coil is wound, the creeping distance between the first coil and the second coil can be increased by the axial length of the protrusion.

Therefore, appropriately setting the length of the protrusion allows a predetermined creeping distance between the first and second coils to be ensured. As a result, the predetermined insulation distance can be readily ensured with no increase in the overall size of the transformer, and the number of constituent parts can be reduced to achieve cost reduction because no insulating case is required, unlike in the related art.

Further, in the case where the insulating member having a flat plate shape is disposed between the second coil and the core, as in the second aspect of the present invention (invention described in claim 2), forming the second protrusion that protrudes into the space between the protrusion and the outer circumference of the second coil on the surface of the insulating member on the side facing the second coil allows the creeping distance between the first coil and the second coil to be the axial length of the protrusion to which the axial length of the portion where the protrusion and the second protrusion overlap with each other is added. The present invention can therefore be readily applied to a higher-current-specification transformer.

### BRIEF DESCRIPTION OF DRAWINGS

FIG. 1 is a longitudinal cross-sectional view showing a first embodiment of a transformer according to the present invention.

FIG. 2 is a longitudinal cross-sectional view showing a second embodiment of the present invention.

FIG. 3 is a longitudinal cross-sectional view showing a transformer of related art.

FIG. 4 is a longitudinal cross-sectional view showing another transformer of related art.

FIG. 5 is a longitudinal cross-sectional view of FIG. 4 in the form of a side view.

### DESCRIPTION OF EMBODIMENTS

### First Embodiment

FIG. 1 shows a first embodiment of a transformer according to the present invention, and reference character 10 in FIG. 1 denotes a bobbin (first bobbin).

The bobbin 10 includes a cylindrical wire winding section 10a and flanges 10b, which each has a circular ring plate shape and are integrated with opposite ends of the wire winding section 10a, and a stranded wire is wound in an a winding manner around the outer circumference of the wire winding section 10a to form a high-voltage coil (first coil) 11. A low-voltage coil (second coil) 12 is disposed on the outer surface of each of the flanges 10a at opposite ends of the bobbin 10.

Each of the low-voltage coils 12 is produced in a stamping process in which a copper plate (metal flat plate) is stamped in an open ring shape and is disposed coaxially with the high-voltage coil 11.

The bobbin 10, around which the high-voltage coil 11 is wound, and the low-voltage coils 12 are accommodated in an insulating case 13.

The case 13 has a bottomed, cylindrical shape formed of a bottom plate (insulating member) 14, which has a circular disk plate shape, and a cylindrical sidewall 15, which is so formed that it is integrated with the outer circumferential edge of the bottom plate 14 to surround the outer circumference of the high-voltage coil 11 and the low-voltage coils 12, and the opening of the case 13 is closed with a cap (insulating member) 16.

A pair of E-shaped cores 17, which form a closed magnetic circuit, are disposed around the outer circumferences of the case 13 and the cap 16 in such a way that the cores 17 face each other. A middle leg 17a of each of the E-shaped cores 17 is inserted into the opening of the case 13 and an opening formed in central portions of the cap 16 and further into a through hole in the bobbin 10, and an outer leg 17b of each of the cores 17 is disposed along the sidewall 15 of the case 13.

Further, in the transformer, a cylindrical protrusion 18 is so formed that it is integrated with an outer circumferential portion of each of the flanges 10b of the bobbin 10, and the protrusions 18 extend in the axial direction of the bobbin 10 and surround the outer circumferences of the low-voltage coils 12. A cylindrical second protrusion 19 is formed on and integrated with each of the bottom plate 14 of the case 13 and the surface of the cap 16 on the side facing the low-voltage coils 12, and the protrusions 19 protrude toward the flanges 10b of the bobbin 10 into the spaces between the protrusions 18 and the outer circumferences of the low-voltage coils 12.

The axial length of the protrusions 18 is so set that in a state in which the bobbin 10 and the low-voltage coils 12 are accommodated in the case 13 and the cap 16 is attached thereto, the front end of each of the protrusions 18 comes into contact with the bottom plate 14 of the case 13 or the cap 16.

The second protrusions 19 are formed in positions where they accommodate the low-voltage coils 12 and restrict movement of the low-voltage coils 12 in the direction perpendicular to the axial line thereof, and the axial length of the second protrusions 19 is so set that in the state in which the bobbin 10 and the low-voltage coils 12 are accommodated in the case 13 and the cap 16 is attached thereto, the front end of each of the protrusions 19 comes into contact with the corresponding flange 10b of the bobbin 10.

In the thus configured transformer, the cylindrical protrusions 18, which surround the outer circumferences of the low-voltage coils 12, are formed along the outer circumferential edges of the flanges 10b of the bobbin 10, around which the high-voltage coil 11 is wound, and the second protrusions 19, which protrude toward the flanges 10b of the bobbin 10 into the spaces between the protrusions 18 and the outer circumferences of the low-voltage coils 12, are formed on the bottom plate 14 of the case 13 and the surface of the cap 16 on the side facing the low-voltage coils 12.

As a result, a creeping distance L₁ between the high-voltage coil 11 and each of the low-voltage coils 12 is the axial length of the protrusion 18 measured from the outer circumference of the high-voltage coil 11 to which the axial length of the portion where the protrusion and the second protrusion overlap with each other is added. Further, a creeping distance L₂ between the high-voltage coil 11 and each of the cores 17 is the axial length of the protrusion 18 measured from the outer circumference of the high-voltage coil 11 (=length to cap 16).

As described above, since the protrusions 18 and the second protrusions 19 described above allow the creeping distance L₁ between the high-voltage coil 11 and each of the low-voltage coils and the creeping distance L₂ between the high-voltage coil 11 and each of the cores 17 to be increased, a required creeping distance can be ensured by appropriately setting the axial length of each of the protrusions 18 and the second protrusions 19.

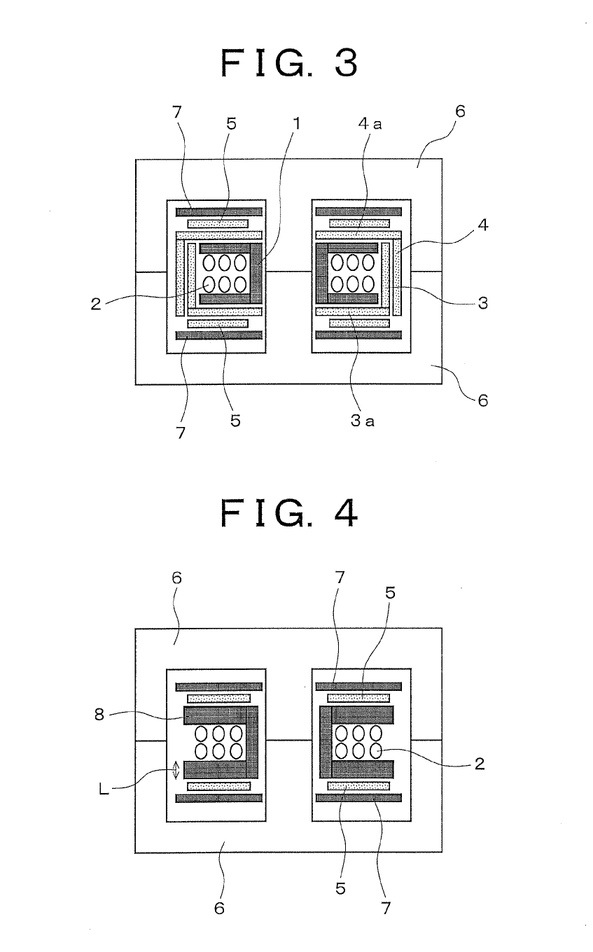

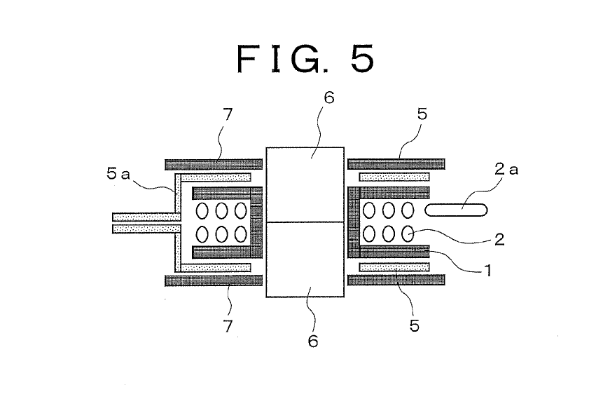

Predetermined insulation distances L₁ and L₂ can therefore be readily ensured with no increase in the overall size of the transformer. Further, the number of constituent parts can be reduced to achieve cost reduction, as compared with the number of parts and cost in the related art shown in FIG. 3.

In addition, at the time of assembly, the second protrusions 19, which are formed on the bottom plate 14 of the case 13 and the cap 16, advantageously allow the low-voltage coils 12 to be extremely readily positioned and assembled.

### Second Embodiment

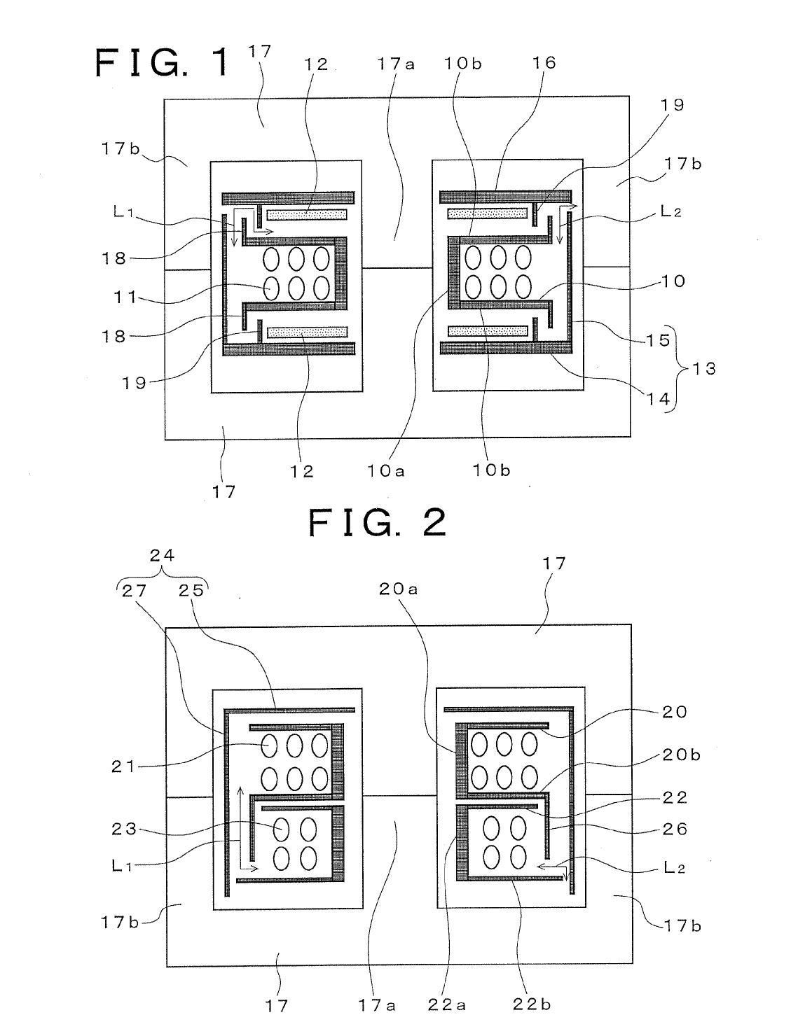

FIG. 2 shows a second embodiment of the transformer according to the present invention. The E-shaped cores 17 have the same configuration as that shown in FIG. 1 and therefore have the same reference character and are described in a simplified manner.

In the transformer according to the second embodiment, a high-voltage coil (first coil) 21, which is formed of a stranded wire wound in an a-winding manner around a wire winding section 20a of a bobbin (first bobbin) 20, and a low-voltage coil (second coil) 23, which is formed of a copper wire or a stranded wire wound in an α-winding manner around a wire winding section 22a of a bobbin (second bobbin) 22, are axially disposed adjacent to each other.

The bobbins 20 and 22 axially layered on each other are accommodated in a bottomed, cylindrical case 24. The bobbin 20, around which the high-voltage coil 21 is wound, is disposed in a position shifted toward a top plate (insulating member) 25 of the case 24, and the bobbin 22, around which the low-voltage coil 23 is wound, is disposed in a position shifted toward the opening of the case 24. As a result, a flange 22b of the bobbin 22 on the side facing the opening of the case 24 serves as an insulating member between the low-voltage coil 23 and the corresponding one of the E-shaped cores 17.

Further, in the transformer according to the second embodiment, a cylindrical protrusion 26, which axially extends and surrounds the outer circumference of the low-voltage coil 23, is so formed on and integrated with the outer circumferential edge of a flange 20b of the bobbin 20 on the side adjacent to the bobbin 22, around which the low-voltage coil 23 is wound. The axial length of the protrusion 26 is so set that in a state in which the two bobbins 20 and 22 are layered on each other, the front end of the protrusion 26 comes into contact with the flange 22b of the bobbin 22 on the side facing the opening of the case 24.

Further, the outer diameter of the flange 22b that faces the opening is set to be greater than the diameter of the protrusion 26 of the bobbin 20, more specifically, the outer circumferential edge of the flange 22b is closer to a sidewall 27 of the case 24 than the protrusion 26.

According to the transformer having the configuration described above, since the protrusion 26, which covers the outer circumference of the low-voltage coil 23, is formed on the flange 20b of the bobbin 20, around which the high-voltage coil 21 is wound, a creeping distance L₁ between the high-voltage coil 21 and the low-voltage coil 23 is increased by the axial length of the protrusion 26 measured from the outer circumference of the high-voltage coil 21. Further, a creeping distance L₂ between the low-voltage coil 23 and each of the cores 17 is the length from the outer circumferential edge of the flange 22b of the bobbin 22 to the outer circumference of the low-voltage coil 23.

As a result, a required creeping distance can be ensured by appropriately setting the outer diameters of the protrusion 26 and the flange 22b of the bobbin 22 on the side facing the opening of the case 24, whereby the same advantageous effects shown in the first embodiment can be provided.

### INDUSTRIAL APPLICABILITY

The present invention can provide a transformer capable of readily ensuring a predetermined insulation distance with no increase in the overall size of the transformer and further capable of reducing the number of constituent parts to achieve cost reduction.

### REFERENCE SIGNS LIST

10, 20 Bobbin (first bobbin)

10a, 20a, 22a Wire winding section

10b, 20b 22b Flange

11, 21 High-voltage coil (first coil)

12, 23 Low-voltage coil (second coil)

14 Bottom plate of case (insulating member)

16 Cap (insulating member)

17 E-shaped core

18 Protrusion

19 Second protrusion

22 Bobbin (second bobbin)

25 Top plate of case (insulating member)

L₁, L₂ Creeping distance

1. A transformer comprising: a first bobbin having a wire winding section and a flange formed at an end of the wire winding section; a first coil wound around an outer circumference of the wire winding section of the first bobbin; a second coil disposed coaxially with the first coil and adjacent to the flange; and a core disposed around outer circumferences of the first and second coils to form a closed magnetic circuit,
wherein a tubular protrusion that axially extends and surrounds the outer circumference of the second coil is formed along an outer circumferential portion of the flange of the first bobbin.

2. The transformer according to claim 1,
wherein an insulating member having a flat plate shape is disposed between the second coil and the core, and a second protrusion that protrudes into a space between the protrusion and the outer circumference of the second coil is formed on a surface of the insulating member on a side facing the second coil.

3. The transformer according to claim 1,
wherein the first coil is a high-voltage coil with a stranded wire wound around the wire winding section, and the second coil is a low-voltage coil formed of a metal flat plate shaped in an open circular ring.

4. The transformer according to claim 1,
wherein the first coil is a high-voltage coil with a stranded wire wound around the wire winding section and is disposed in a bottomed, tubular, insulating cover, the second coil is wound around a second bobbin and disposed on a side facing an opening of the insulating cover, and a flange of the second bobbin that is located on the side facing the opening is formed to have a diameter greater than a diameter of the protrusion on the first bobbin.
